(19) United States
(12) Patent Application Publication
(10) Pub. No.: US 2015/0189036 A1
(43) Pub. Date: Jul. 2, 2015

(54) OFFLINE CACHING METHOD AND APPARATUS

(71) Applicant: TENCENT TECHNOLOGY (SHENZHEN) COMPANY LIMITED, Shenzhen (CN)

(72) Inventors: Jie HE, Shenzhen (CN); Zhengkun LU, Shenzhen (CN); Mingqiang LI, Shenzhen (CN); Tieming HUANG, Shenzhen (CN)

(21) Appl. No.: 14/657,483

(22) Filed: Mar. 13, 2015

Related U.S. Application Data
(63) Continuation of application No. PCT/CN2013/081832, filed on Aug. 20, 2013.

(30) Foreign Application Priority Data
Sep. 20, 2012 (CN) 201210351924.7

(51) Int. Cl. H04L 29/08

(52) U.S. Cl. CPC H04L 67/2842; H04L 67/02

(57) ABSTRACT

Embodiments of the present disclosure provide an offline caching method and apparatus. In this method, a resource downloading request may be intercepted. An identifier of a resource may be obtained from the resource downloading request. It may be determined whether the resource corresponding to the identifier is saved in a local database. The resource corresponding to the identifier may be encapsulated and a response may be made to the resource downloading request if the resource corresponding to the identifier is saved in the local database.

### CROSS-REFERENCE TO RELATED APPLICATIONS

This application is a continuation of International Application No. PCT/CN2013/081832, filed on Aug. 20, 2013, which claims priority to Chinese patent application No. 201210351924.7, filed on Sep. 20, 2012, the contents of both of which are incorporated herein by reference in their entireties.

### FIELD OF THE INVENTION

The present disclosure relates to Internet technologies, and more particularly, to an offline caching method and apparatus.

### BACKGROUND

With rapid development of mobile Internet, more and more mobile applications applied to a user terminal are developed. Furthermore, mobile medical equipment is becoming an indispensable part of the Internet user terminal and is used at any time on various occasions.

### SUMMARY

An embodiment of the present disclosure provides an offline caching method, to enhance communication speed, communication fluency and communication efficiency of the user terminal.

An embodiment of the present disclosure provides an offline caching method, including:

intercepting a resource downloading request;

obtaining an identifier of a resource from the resource downloading request; determining whether the resource corresponding to the identifier is saved in a local database;

encapsulating the resource corresponding to the identifier and making a response to the resource downloading request if the resource corresponding to the identifier is saved in the local database.

Another embodiment of the preset disclosure provides an offline caching apparatus, including: a local database and a processor.

The local database is to store a downloaded resource.

The processor is to

intercept a resource downloading request;

obtain an identifier of a resource from the resource downloading request; determine whether the resource corresponding to the identifier is saved in a local database;

encapsulate the resource corresponding to the identifier and make a response to the resource downloading request if the resource corresponding to the identifier is saved in the local database.

Another embodiment of the present disclosure provides a non-transitory computer readable storage medium, storing computer readable instructions, which are executed by a computer to:

intercept a resource downloading request;

obtain an identifier of a resource from the resource downloading request;

determine whether the resource corresponding to the identifier is saved in a local database;

encapsulate the resource corresponding to the identifier and make a response to the resource downloading request if the resource corresponding to the identifier is saved in the local database.

With the technical scheme in embodiments of the present disclosure, when a user needs to use the resource and initiate the resource downloading request via the user terminal, the identifier corresponding to the resource may be obtained from the resource downloading request. It may be determined whether the resource corresponding to the identifier is saved in the local database according to the identifier. If the resource corresponding to the identifier is saved in the local database, the resource may be obtained from the local database and the response may be made to the resource downloading request. With this technical scheme, it may be avoided that the resource saved in the local database may be repeatedly downloaded. Furthermore, the performance of the user terminal may be enhanced.

### BRIEF DESCRIPTION OF THE DRAWINGS

In order to clearly describe the technical scheme in the present disclosure, a brief description is given to accompanying figures used in following examples. Obviously, the accompanying figures described hereinafter are some examples in the present disclosure. An ordinary skilled in the art may obtain other figures with these accompanying figures without creative work.

FIG. 1 is a flow chart illustrating an offline caching method in accordance with various embodiments of the present disclosure;

FIG. 2 is a flow chart illustrating another offline caching method in accordance with various embodiments of the present disclosure;

FIG. 3 is a flow chart illustrating a method for sending a resource downloading request to a remote end in an offline caching method in accordance with various embodiments of the present disclosure;

FIG. 4 is a flow chart illustrating another offline caching method in accordance with various embodiments of the present disclosure;

FIG. 5 is a diagram illustrating structure of an offline caching apparatus in accordance with various embodiments of the present disclosure;

FIG. 6 is a diagram illustrating another offline caching apparatus in accordance with various embodiments of the present disclosure;

FIG. 7 is a diagram illustrating structure of a remote request module in the offline caching apparatus in accordance with various embodiments of the present disclosure; and

FIG. 8 is a diagram illustrating structure of another offline caching apparatus in accordance with various embodiments of the present disclosure.

### DETAILED DESCRIPTION

The most important feature of the mobile Internet is mobility. The user terminal may use the Internet in a situation that the physical position of the user terminal may change. The mobile Internet provides the user terminal with great convenience. However, the area covered by the current mobile network is not wide and the user terminal cannot use the mobile Internet anywhere, at any time. Therefore, some mobile applications use an offline caching technology to save downloaded resources locally. The user terminal may use these resources without the network. This technology may reduce traffic used by the user terminal and satisfy individualized needs of the user terminal.

Generally, an offline caching function in a Hypertext Markup Language (HTML)5 format may be adopted. In recent ten years, the HTML 5 develops rapidly. On the HTML 5 platform, audio, video, image, animation and interaction between a mobile terminal and a PC has been standardized. The functions of the HTML5 are getting rich. The most important function of the HTML5 is an offline caching mobile Web application. Based on the offline caching function of the HTML5, many mobile applications are developed with the HTML5. These applications are called mobile Web applications. The mobile application mainly uses the HTML5 technology and is able to run in a text browser, such as a Javascript and a Cascading Style Sheet (CSS.) The mobile application developed with the HTML5 offline caching also has the offline caching function. The HTML5 offline caching function may provide an offline storage function via an Application Caching Interface (API), designate a browser to caching a specific file (i.e. resources accessed by the browser), so that an offline user may access the specific file.

The above application development mode for using the HTML5 offline function to implement the offline caching function of the mobile application may be called a mixing type development. The best characteristic of the mobile application developed with the above development scheme is cross-platform support. Since the mobile application needs to use the browser when the mobile application downloads a file, downloading speed, downloading fluency and downloading efficiency, etc., may be affected.

It should be understood that the embodiments may be used for explaining the present disclosure and may not be used for limiting the present disclosure.

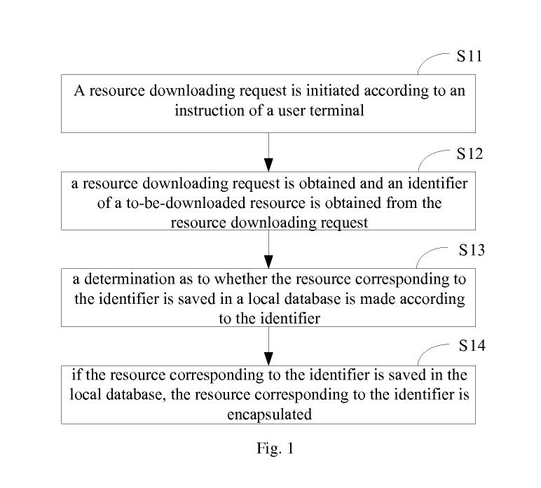

Referring to FIG. 1, FIG. 1 is a flow chart illustrating an offline caching method in accordance with various embodiments of the present disclosure.

In block S12, a resource downloading request may be obtained and an identifier of a to-be-downloaded resource may be obtained from the resource downloading request.

In block S13, a determination as to whether the resource corresponding to the identifier is saved in a local database may be made according to the identifier.

In block S14, if the resource corresponding to the identifier is saved in the local database, the resource corresponding to the identifier may be encapsulated.

In an example, before block S12, there may be a block S11 for sending the resource downloading request according to an instruction of a user terminal.

In a situation that a user terminal may access the Internet, especially the network environment is good, such as the network connection is fast and the network disconnection is less likely to occur, the resource may be obtained from the remote server on the Internet and the resource may be saved in the local database of the user terminal. When the user terminal needs to use the resource again, the user terminal may intercept the resource downloading request sent to the remote end, such as the server for obtaining the resource. For instance, the resource downloading request may be a Hyper Text Transfer Protocol (HTTP) request. The identifier, such as a Uniform Resource Locator (URL) corresponding to the resource in the resource downloading request may be obtained and the local database may be searched. If the requested resource is already cached in the local database, the resource may be obtained from the local database, the resource may be encapsulated into an HTTP response and the HTTP response may be returned in response to the HTTP request. With this scheme, it may be avoided that the resource in the local database may be repeatedly downloaded. Furthermore, the network traffic used by the user may be saved.

Furthermore, in a situation that a user terminal may access the Internet, especially the network environment is good, the user terminal may obtain the resource from the server and save the resource in the local database. Therefore, the user may read the resource from the local database when the user terminal disconnects with the network. With this offline caching method, it may be permitted that the user may use the resource when the user terminal disconnects with the network.

The offline caching method may further include: downloading the resource from a remote end and save the resource in the local database.

The method for determining whether the resource corresponding to the identifier is saved in the local database according to identifier may include:

searching for the local database according to the identifier and determine whether the resource corresponding to the identifier is saved in the local database.

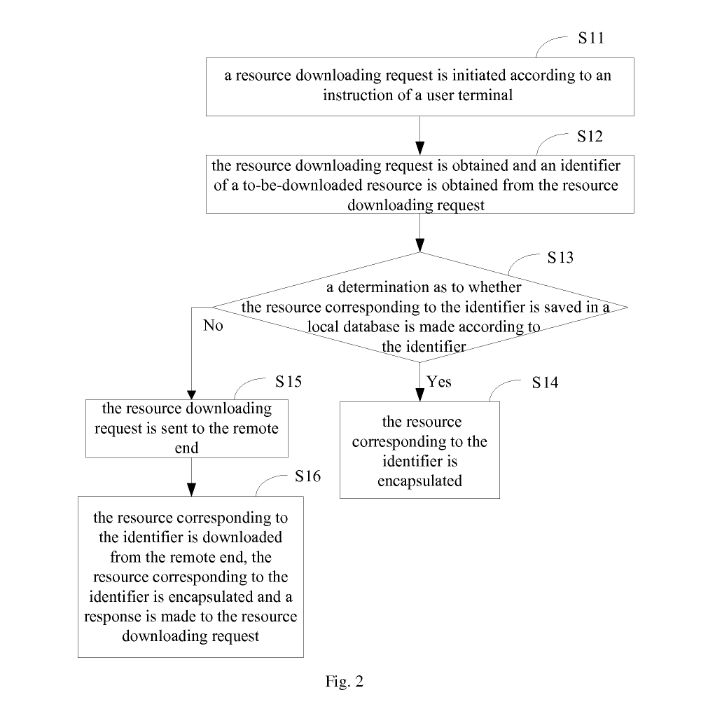

Referring to FIG. 2, FIG. 2 is a flow chart illustrating another offline caching method in accordance with various embodiments of the present disclosure. In this embodiment, after the above block S13, following blocks may be included.

In block S15, when the resource corresponding to the identifier is not saved in the local database, the resource downloading request may be sent to the remote end.

In block S16, the resource corresponding to the identifier may be downloaded from the remote end, the resource corresponding to the identifier may be encapsulated, a response may be made to the resource downloading request and the resource corresponding to the identifier may be saved in the local database taking the identifier as a keyword.

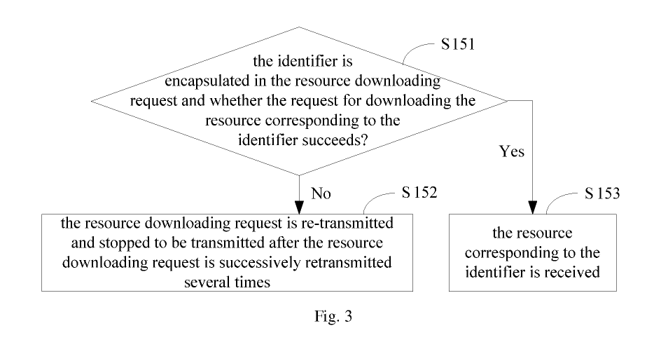

Referring to FIG. 3, FIG. 3 is a flow chart illustrating a method for sending the resource downloading request to the remote end in an offline caching method in accordance with various embodiments of the present disclosure. The above block S15 may include following blocks.

In block S151, the identifier may be encapsulated in the resource downloading request and the resource corresponding to the identifier may be requested to be downloaded from the remote end. When the request fails, block S152 may be performed. When the request succeeds, block S153 may be performed. The resource corresponding to the identifier may be called a remote resource.

In block S152, the resource downloading request may be re-transmitted and stopped to be transmitted after the resource downloading request is successively retransmitted several times.

In block S153, the resource corresponding to the identifier may be received.

When the resource corresponding to the identifier in the resource downloading request is not saved in the local database of the user terminal, the identifier obtained from the resource downloading request may be re-encapsulated, the resource downloading request may be re-generated and the resource may be requested to be downloaded from the Internet remote end server. If the request succeeds, the downloaded resource may be encapsulated to make a response to the resource downloading request after the downloading of the resource corresponding to the identifier is completed. The resource corresponding to the identifier may be saved in the local database taking the identifier as the keyword. If the request fails, the resource downloading request may be re-transmitted and the transmission of the resource downloading request may be stopped after the resource downloading request is successively retransmitted many times.

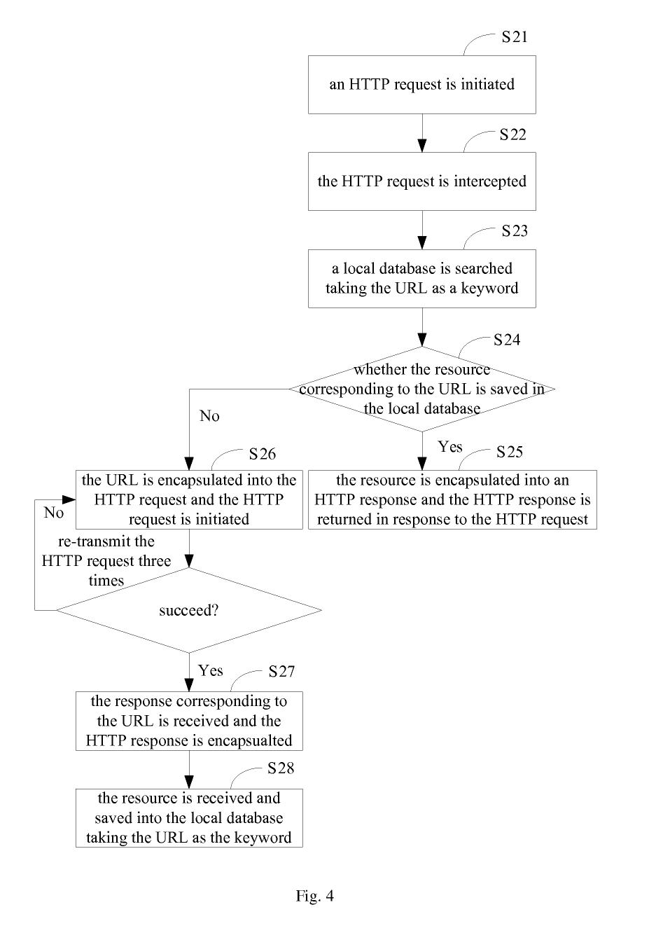

Referring to FIG. 4, FIG. 4 is a flow chart illustrating another offline caching method in accordance with various embodiments of the present disclosure. For example, if the offline caching method is applied to the mobile application, the offline caching method in this embodiment may be described in detail. A resource downloading request may be an HTTP request and an identifier of a resource may be a URL.

In block S21, a mobile application may initiate a HTTP request according to an instruction of a mobile user terminal to request for downloading a resource from a remote server.

In block S22, the mobile application may intercept the HTTP request.

In block S23, a URL of the requested resource may be parsed from the HTTP request.

In block S24, a local database of the mobile terminal may be searched taking the URL as a keyword.

In block S25, if the resource corresponding to the URL is saved in the local database, the resource corresponding to the URL may be encapsulated into an HTTP response and returned to the mobile application initiating the HTTP request. Till then, a process for initiating the HTTP request by the mobile application may end.

In block S26, if the resource corresponding to the URL is not saved in the local database, the URL may be encapsulated in the HTTP request and the HTTP request may be sent out. If the HTTP request is not successfully initiated, the HTTP request may be re-transmitted. The transmission of the HTTP request may be stopped if the HTTP request is successively transmitted three times and the three transmission fails.

In block S27, if the HTTP request succeeds, the resource corresponding to the URL may be received, an HTTP response may be encapsulated and returned to the mobile application in response to the HTTP request.

In block S28, the received resource may be saved in a local database taking the URL as a keyword. Till then, the HTTP request process initiated by the mobile application may end.

In the mobile user terminal (such as a smartphone and a table PC), the native mobile application has its advantages and weblization of the native mobile application may be difficult to be implemented in a period of time in the future. Therefore, the offline caching technology utilizing the native mobile application may greatly enhance the performance (such as speed and efficiency, etc.) of the mobile application and provide the mobile Internet user terminal with convenience.

With the above offline caching method, the network traffic used by the user terminal may be reduced. In a situation that a user terminal may access the Internet, especially the network environment is good, the resource may be requested and the resource may be saved to the local database. Therefore, the time required by the request of the resource may be reduced. In a bad network environment, the resource may be obtained from the local database. Therefore, it may be avoided that the source saved in the local database may be repeatedly downloaded and the performance of the user terminal may be enhanced.

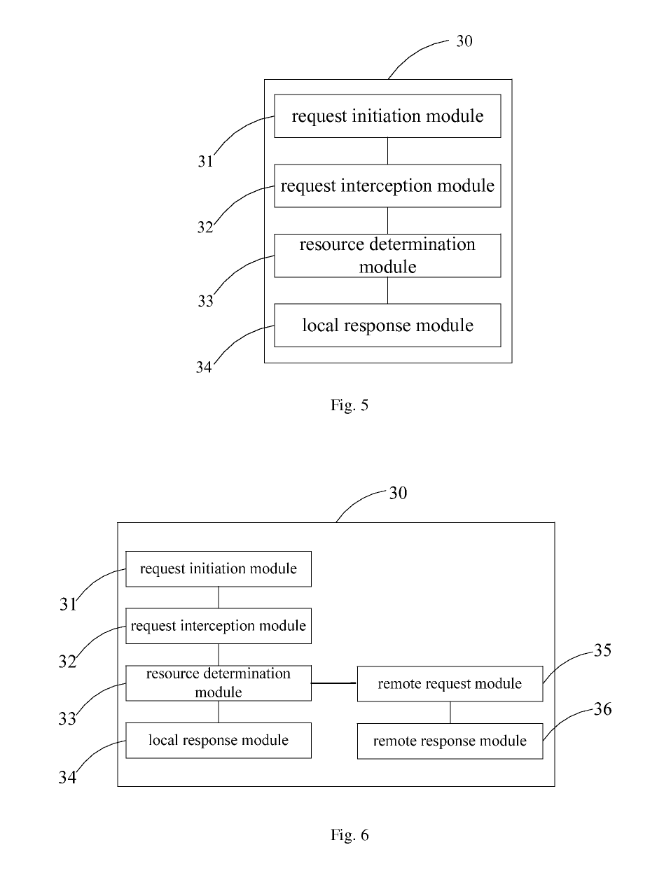

Referring to FIG. 5, FIG. 5 is a diagram illustrating an offline caching apparatus in accordance with various embodiments of the present disclosure. This embodiment may provide an offline caching apparatus 30. The offline caching apparatus 30 may include: a request initiation module 31, a request interception module 32, a resource determination module 33 and a local response module 34.

The request initiation module 31 may be configured to initiate a resource downloading request according an instruction of a user terminal. The request interception module 32 may be configured to intercept the resource downloading request and obtain an identifier of a to-be-downloaded resource from the resource downloading request. The resource determination module 33 may be configured to determine whether the resource corresponding to the identifier is saved in a local database according to the identifier. The local response module 34 may be configured to encapsulate the resource corresponding to the identifier and make a response to the resource downloading request to finish the resource downloading when the resource corresponding to the identifier is saved in the local database.

In a situation that a user terminal may access the Internet, especially the network environment is good, such as the network connection is fast and the network disconnection is less likely to occur, the offline caching apparatus 30 may obtain the resource from the remote server on the Internet and the resource may be saved in the local database of the user terminal. When the user terminal needs to use the resource again, the user terminal may intercept the resource downloading request sent to the remote end, such as the server for obtaining the resource. For instance, the resource downloading request may be a Hyper Text Transfer Protocol (HTTP) request. The identifier, such as a Uniform Resource Locator (URL) corresponding to the resource in the resource downloading request may be obtained and the local database may be searched. If the requested resource is already cached in the local database, the resource may be obtained from the local database and the resource may be encapsulated into an HTTP response and the HTTP response may be returned in response to the HTTP request. With this offline caching apparatus 30, it may be avoided that the resource in the local database is repeatedly downloaded. Furthermore, the network traffic used by the user may be saved.

Referring to FIG. 6, FIG. 6 is a diagram illustrating structure of another offline caching apparatus in accordance with various embodiments of the present disclosure. Compared to the embodiment shown in FIG. 5, the offline caching apparatus 30 may further include: a remote request module 35 and a remote response module 36. The remote request module 35 may be configured to send the resource downloading request to the remote end when the resource corresponding to the identifier is not saved in the local database. The remote response module 36 may be configured to encapsulate the resource corresponding to the identifier and make a response to the resource downloading request after the resource corresponding to the identifier is downloaded from the remote end and save the resource corresponding to the identifier in the local database taking the identifier as a keyword.

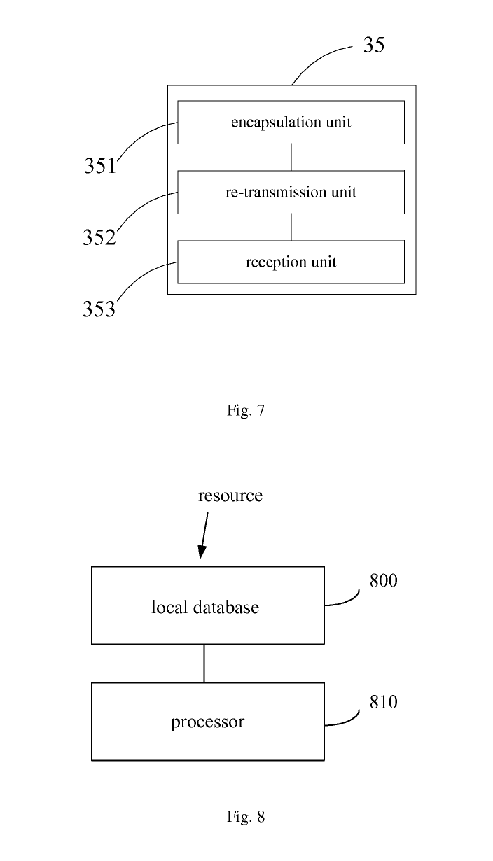

Referring to FIG. 7, FIG. 7 is a diagram illustrating the remote request module 35 in the offline caching apparatus 30 in accordance with various embodiments of the present disclosure. The remote request module 35 may include: an encapsulation unit 351, a re-transmission unit 352 and a reception unit 353. The encapsulation unit 351 may be configured to encapsulate the identifier into the resource downloading request and download the resource corresponding to the identifier from the remote end. The re-transmission unit 352 may be configured to re-transmit the resource downloading request when the request fails and stop transmitting the resource downloading request after the resource downloading request is successively transmitted many times. When the request succeeds, the reception unit 353 may be configured to receive the resource from the remote end.

When the resource corresponding to the identifier in the resource downloading request is not saved in the local database of the user terminal, the identifier obtained from the resource downloading request may be re-encapsulated, the resource downloading request may be re-generated and the resource may be requested to be downloaded from the Internet remote end server. If the request succeeds, the downloaded resource may be encapsulated to make a response to the resource downloading request after the downloading of the resource corresponding to the identifier is completed. The resource corresponding to the identifier may be saved in the local database taking the identifier as the keyword. If the request fails, the resource downloading request may be re-transmitted and transmission of the resource downloading request may be stopped after the resource downloading request is successively retransmitted many times (such as three times).

With the above offline caching apparatus 30, the network traffic used by the user terminal may be reduced. In a situation that a user terminal may access the Internet, especially the network environment is good, the resource may be requested and the resource may be saved to the local database. Therefore, with the offline caching apparatus 30, the time required by the request of the resource may be reduced. In a bad network environment, the resource may be obtained from the local database. Therefore, it may be avoided that the source saved in the local database may be repeatedly downloaded. Furthermore, the performance of the user terminal may be enhanced.

Referring to FIG. 8, FIG. 8 is a diagram illustrating another offline caching apparatus in accordance with various embodiments of the present disclosure. The offline caching apparatus may include: a local database 800 and a processor.

The local database 800 may be configured to store a downloaded resource.

The processor 810 may be configured to intercept a resource downloading request, obtain an identifier of a to-be-downloaded resource from the resource downloading request, determine whether the resource corresponding to the identifier is saved in the local database 800 according to the identifier, encapsulate the resource corresponding to the identifier and make a response to the resource downloading request when the resource corresponding to identifier is saved in the local database 800.

In another example of the present disclosure, the processor 810 is further configured to send the resource downloading request to the remote end when the resource corresponding to the identifier is not saved in the local database 800, download the resource corresponding to the identifier from the remote end, encapsulate the source corresponding to the identifier, make a response to the resource downloading request and save the resource corresponding to the identifier in the local database 800 taking identifier as a keyword.

In another example of the present disclosure, the processor may be further configured to encapsulate the identifier into the resource downloading request and request the remote end for downloading the resource corresponding to the identifier, re-transmit the resource downloading request when the request fails and stop transmitting the resource downloading request after the resource downloading request is successively transmitted many times.

The resource downloading request may be an HTTP request and the identifier may be a URL.

In an example of the present disclosure, the processor 810 may be further configured to encapsulate the resource corresponding to the identifier in the local database 800 into an HTTP response and send the HTTP response to the user terminal initiating the HTTP request.

In an example of the present disclosure, the processor 810 may be further configured to search for the local database 800 according to the identifier and determine whether the resource corresponding to the identifier is saved in the local database 800.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An offline caching method, comprising:
intercepting a resource downloading request;
obtaining an identifier of a resource from the resource downloading request;
determining whether the resource corresponding to the identifier is saved in a local database;
encapsulating the resource corresponding to the identifier and making a response to the resource downloading request if the resource corresponding to the identifier is saved in the local database.

2. The method according to claim 1, further comprising:
sending the resource downloading request to a remote end if the resource corresponding to the identifier is not saved in the local database;
downloading the resource corresponding to the identifier from the remote end;
encapsulating the resource corresponding to the identifier;
making a response to the resource downloading request; and
saving the resource corresponding to the identifier in the local database taking the identifier as a keyword.

3. The method according to claim 2, wherein sending the resource downloading request to the remote end comprises:
encapsulating the identifier in the resource downloading request;
requesting for downloading the resource corresponding to the identifier from the remote end;
re-transmitting the resource downloading request if the requesting fails; and
stopping transmitting the resource downloading request after the resource downloading request is successively transmitted several times.

4. The method according to claim 1, wherein
the resource downloading request comprises: a Hyper Text Transfer Protocol (HTTP) request; and
the identifier comprises: a Uniform Resource Locator (URL).

5. The method according to claim 4, wherein encapsulating the resource corresponding to the identifier in the local database and making the response to the resource downloading request comprises:
encapsulating the resource corresponding to the identifier in the local database into an HTTP response; and
returning the HTTP response to a user terminal initiating an HTTP request.

6. The method according to claim 1, further comprising:
downloading the resource from a remote end;
saving the resource in the local database;
wherein determining whether the resource corresponding to the identifier is saved in the local database according to the identifier comprises:
searching for the local database according to the identifier;
determining whether the resource corresponding to the identifier is saved in the local database.

7. An offline caching apparatus, comprising:
a local database and a processor; wherein
the local database is to store a downloaded resource; and
the processor is to
intercept a resource downloading request;
obtain an identifier of a resource from the resource downloading request;
determine whether the resource corresponding to the identifier is saved in a local database;
encapsulate the resource corresponding to the identifier and make a response to the resource downloading request if the resource corresponding to the identifier is saved in the local database.

8. The apparatus according to claim 7, wherein the processor is further to:
send the resource downloading request to a remote end if the resource corresponding to the identifier is not saved in the local database;
download the resource corresponding to the identifier from the remote end;
encapsulate the resource corresponding to the identifier;
make the response to the resource downloading request; and
save the resource corresponding to the identifier in the local database taking the identifier as a keyword.

9. The apparatus according to claim 8, wherein the processor is further to encapsulate the identifier into the resource downloading request;
request for downloading the resource corresponding to the identifier from the remote end;
re-transmit the resource downloading request if the requesting fails; and
stop transmitting the resource downloading request after the resource downloading request is successively transmitted several times.

10. The apparatus according to claim 7, wherein
the resource downloading request comprises: a Hyper Text Transfer Protocol (HTTP) request; and
the identifier comprises: a Uniform Resource Locator (URL).

11. The apparatus according to claim 10, wherein the processor is further to encapsulate the resource corresponding to the identifier in the local database into an HTTP response and return the HTTP response to a user terminal initiating an HTTP request.

12. The apparatus according to claim 7, wherein the processor is further to
search for the local database according to the identifier;
determine whether the resource corresponding to the identifier is saved in the local database.

13. A non-transitory computer readable storage medium, storing computer readable instructions, which are executed by a computer to:
intercept a resource downloading request;
obtain an identifier of a resource from the resource downloading request;
determine whether the resource corresponding to the identifier is saved in a local database;
encapsulate the resource corresponding to the identifier and make a response to the resource downloading request if the resource corresponding to the identifier is saved in the local database.
